(19) United States
(12) Patent Application Publication
(10) Pub. No.: US 2004/0178897 A1
(43) Pub. Date: Sep. 16, 2004

(54) System and method for monitoring tire pressure in motor vehicles

(76) Inventors: Helmut Fennel, Bad Soden (DE); Peter Sager, Friedrichsdorf (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/483,155

(22) PCT Filed: Jul. 5, 2002
(86) PCT No.: PCT/EP02/07445

(30) Foreign Application Priority Data
Jul. 9, 2001 (DE) 101 33 559.2
Aug. 1, 2001 (DE) 101 37 290.6

(51) Int. Cl. B60C 23/00

(52) U.S. Cl. 340/442

(57) ABSTRACT

The invention relates to a method and a tire pressure monitoring system for motor vehicles. The system comprises a direct-measuring tire pressure measuring device on each individual wheel and an indirect-measuring device that detects the tire pressure exclusively by comparing and evaluating the rotational behavior of the individual vehicle wheels. Both pressure measuring systems are structurally and/or functionally united, thereby enabling position detection, among others.

The present invention relates to a tire pressure monitoring system according to the preamble of claim 1 and a method according to the preamble of claim 10.

Different types of tire pressure monitoring systems for motor vehicles are known. Direct-measuring systems, such as TPMS, as disclosed in DE 199 26 616 or DE 199 38 431 (both Continental AG) determine the tire pressure by means of tire pressure measuring modules integrated in the tire's valve. The measured tire pressure along with temperature data is sent to a receiver installed in the vehicle. Such a module may e.g. be mounted close to the valve in the wheel rim or structurally united with said valve. The module is used to measure the tire pressure and the current tire temperature in addition. The pressure and temperature data is transmitted in a wireless manner to a receiver installed in the vehicle and processed in an electronic unit corresponding to the existing alert strategy. The current pressure value is permanently indicated in a display on the control panel in some cases. It is additionally or alternatively possible, depending on the alert strategy, to warn the driver when the inflation pressure falls below a threshold.

With reduced demands placed on the measuring accuracy or when only an alarm function is required, indirect-measuring tire pressure alarm systems have recently come into use. Corresponding systems are inter alia known from DE 100 44114 A1 (P 9777) or EP 0 983 154 A1 (P 8980) under the name DDS (Deflation Detection System, Continental Teves AG & Co. oHG) The indirect systems do not require pressure sensors in the wheels. The measurement of tire pressure loss is rather based exclusively on the measurement of wheel speeds, the comparison of the rotational-speed measured values of the individual wheels and the evaluation of changes of the rotational speeds or the rolling circumferences of the tires. This is because loss in inflation pressure causes a change in the rolling circumference and, thus, a changed wheel speed. This effect is evaluated by means of the system founding on speed measurement. When the reference parameter used with DDS is exceeded as a threshold value, pressure loss is signaled to the driver. The threshold values used are produced in a learning phase preceding the comparison phase. By evaluating comparison values of different wheel pairs, the DDS system is additionally able to detect the position of a wheel with insufficient pressure.

Prior-art pressure measuring systems, either with direct or indirect measurement, suffer from the disadvantage that the measured pressure values found cannot be checked without further provisions. If, for example, safety functions are linked to the determined pressure or temperature data, such as a driver's warning, false alarms are difficult to rule out at least when there is no redundancy concept for the pressure determination.

An object of the present invention is to develop a tire pressure monitoring system which is characterized by a comparatively high degree of accuracy of pressure loss signaling, a high degree of safety of pressure loss signaling and a high degree of safety with respect to errors in indication and which, in addition, permits recognizing at which wheel and in which wheel position pressure loss occurred. This objective shall be achieved with a low total expenditure or manufacturing effort.

It has been found that this object can be achieved by the monitoring system described in claim 1 and the method according to claim 10, the special features involving that the system based on measuring the tire pressure is structurally and/or functionally grouped with a second tire pressure monitoring system detecting the tire pressure exclusively by comparing and evaluating the rotational behavior of the individual vehicle wheels.

The term ‘position detection’ implies that the position of a wheel with a pressure measuring module associated with said wheel can be detected automatically by the system. To this end it is not sufficient that the pressure measuring modules are distinguishable from one another because the allocation to the wheel houses can change when the wheels of the motor vehicle are manually exchanged. Depending on the respective requirement, the inflation pressure shall be processed or indicated for each individual wheel within the driver's interface, or it is sufficient to issue only a general pressure alarm with respect to the wheel position in the event of loss in inflation pressure of one or more wheels.

Per se known direct-measuring pressure measuring systems require additional hardware components for position detection. This additional expenditure in hardware can be drastically reduced according to the invention. Besides, preferably different alarm thresholds for the front or rear axle can be realized. Another advantage of the invention includes that the detection safety of a system is improved by checking with the respectively other system.

Thus, when combining the TPMS function and the measuring principle of DDS with one another, it is possible to track and determine the position of the wheels by using preferably one single central receiving device. The TPMS sensors furnish the absolute pressure data in a system with a corresponding design. When the pressures in the wheels differ, this causes a different wheel circumference and, hence, different wheel speeds. These generally comparatively insignificant wheel speed differences can be detected by DDS and allocated to a wheel position. This allows realizing position detection by appropriate logical operations between the wheels (axlewise and sidewise). Position detection is executed in particular corresponding to the method disclosed in DE 100 44 14 A1 and EP 0 983 154 A1. According to the prior-art DDS method, two or more reference values are produced and compared which differ from one another in their parameters by permutation of the wheel speeds. This allows determining the wheel position for the especially probable case that exactly one wheel exhibits pressure loss. Thus, a low-cost improvement of a TPMS system may be achieved by the combination of the TPMS sensors with wheel speed data.

In this regard, preferably the central receiving device that is e.g. an electronic HF receiving circuit is not equipped with a device for position detection. Per se known pressure measuring systems with position detection require, for example, four receivers or antennas mounted close to the wheels. It is then possible to localize the respective wheel by way of statistic selective schemes (e.g. by way of the intensity of received field).

But also a preferred system of the invention with four receivers may be favorable when the purpose of the system is to automatically detect any desired wheel position immediately after a DDS learning phase.

Further, it is advantageous and preferred that different pressure alarm thresholds are realized by means of the method of the invention, for example, pressure alarm thresholds for each individual wheel or individual axle.

Preferably, wheel-individual receiving devices are provided which receive the measuring signals from the associated tire pressure measuring devices or measuring modules and relay them to a joint evaluating device. These receiving devices may be in particular electronic receivers, amplifiers or passive receiving devices such as antennas.

The combination of the prior-art systems or the extension of the system based on tire pressure measurement by the system exclusively based on rotational speed measurement allows achieving a monitoring system that is only little more sophisticated but in particular more reliable and, thus, safer.

A check can be made even in ranges in which the system based on rotational speed measurement does not supply exact absolute values due to the wide tolerances. If, for example, a pressure sensor signals a rapid pressure drop, at least the wheel speed will give a hint that pressure drop is likely to happen.

A major advantage of this combination is that spurious alarms and learning times, which are usual with DDS, can be reduced to a minimum.

Further, the so obtained reliable pressure data also allow making pressure-responsive interventions into the safety functions and into motor vehicle control systems with ABS, or e.g. into a control system extended with a driving stability control system (ESP), according to a preferred embodiment of the method.

The evaluating device of the tire pressure measuring signals can be accommodated in the electronics of the existing control system or can be designed as a component of a brake and/or driving dynamics controller or controller program. In the last mentioned case, the non-processed signals of the wheel speed sensors are then utilizable by the DDS, further enhancing the accuracy and availability of the system.

Further preferred embodiments can be taken from the sub claims and the following description of an embodiment by making reference to the Figures.

In the drawing,

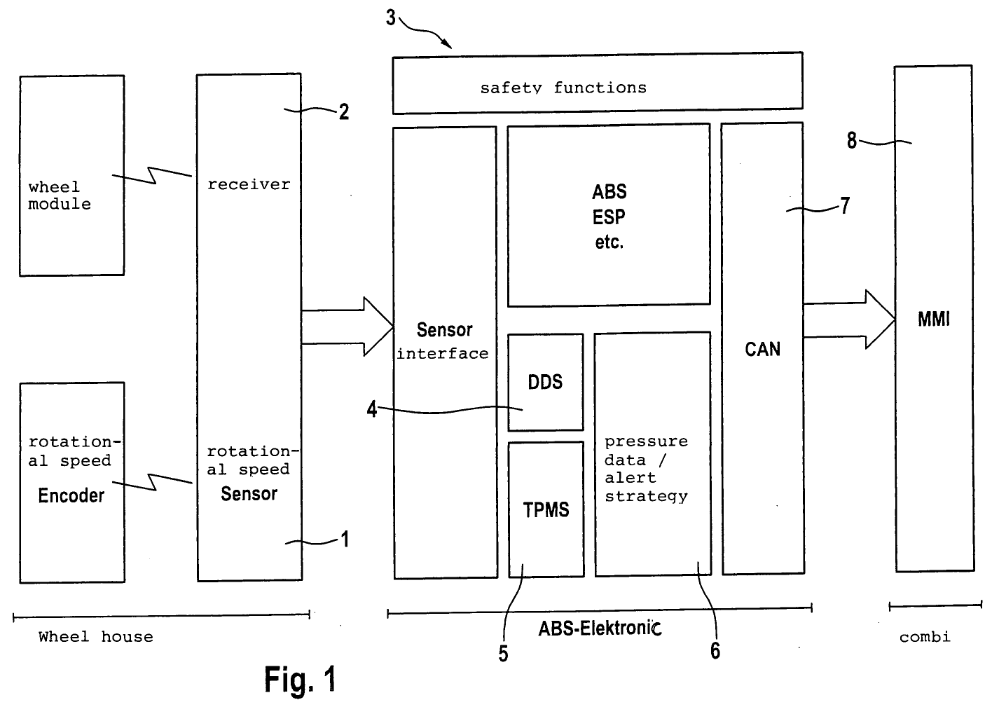

FIG. 1 is a representation of the function blocks of an exemplary tire pressure monitoring system for a passenger car with an electronic brake control device, among others for ABS.

Each wheel house accommodates a per se known ABS wheel speed sensor transmitting, by way of a current interface, wheel speed signals to an ABS control unit in a per se known fashion. The ABS control unit may also comprise additional functions for controlling driving dynamics (e.g. ESP or TCS). Per se known TPMS wheel modules are arranged in the wheels comprising a pressure sensor and a temperature sensor and transmitting these signals and an identifier signal in a wireless manner by way of a transmitting device. The transmitted signals are received in receiving circuits 2 integrated in the wheel speed sensor or by passive antennas mounted in the range of the wheel speed sensor.

In the case of receiving circuits in the range of the wheel houses, the pressure and temperature signals can also be transmitted digitally by way of the wheel speed interface, for example, within a per se known additional protocol in the pauses between the wheel speed pulses.

With the use of passive antennas, the received signal is coupled into the wheel speed sensor line and sent to a receiver integrated in the ABS control unit 3. Previously, the pressure and temperature signal is separated from the wheel speed signal by an appropriate electronic circuit.

Apart from the per se known control algorithms for the braking function, the control unit 3 comprises a DDS algorithm 4 that is extended by program steps for the output of position detection.

Another function block 5 comprises the algorithms and electronic switching means necessary for controlling and evaluating TPMS.

Function block 6 comprises the strategy for the pressure information and the pressure alarm on the basis of data furnished by DDS and TPMS. The data may be configured for different motor vehicle models of defined customers, for example, in such a way that an alarm lamp is allocated individually to each wheel house, said alarm lamp signaling when the pressure falls below a pressure threshold value for each individual position. Alternatively, absolute pressure values can be transmitted individually for each position to a man-machine interface 7 (MMI) e.g. in the control panel. The transmission to the MMI may e.g. take place by means of a standard motor vehicle data bus 8 (e.g. CAN).

1. Tire pressure measuring system for motor vehicles comprising a direct-measuring pressure measuring system which includes on each individual wheel tire pressure measuring devices or tire pressure measuring modules, transmitting devices for transmitting the measured values from the individual wheels to one or more receiving and evaluating devices installed in the vehicle,
characterized in that the direct-measuring system for measuring the tire pressure is structurally and/or functionally grouped with at least one other indirect-measuring tire pressure monitoring system detecting the tire pressure exclusively by comparing and evaluating the rotational behavior of the individual vehicle wheels.

2. Tire pressure monitoring system as claimed in claim 1,
characterized in that several wheel-individual receiving devices are provided, receiving measuring signals from the associated tire pressure measuring devices or measuring modules and relaying them to a common evaluating device.

3. Tire pressure monitoring system as claimed in claim 2,
characterized in that the output signals of the wheel-individual receiving devices are sent to the common evaluating device by way of the connecting lines of the wheel speed sensors.

4. Tire pressure monitoring system as claimed in at least one of claims 1 to 3,
characterized in that a central receiving unit is provided which receives the data based on the measurement of the tire pressure in the individual wheels and relays the data to the evaluating device, and with the pressure measuring values being allocated to the respective mounting position of the wheel comprising a pressure sensor by means of the second monitoring system that is based on the wheel rotational behavior.

5. Tire pressure monitoring system as claimed in claim 4,
characterized in that the receiving unit communicates with the evaluating device by way of a standardized motor vehicle data bus, such as CAN.

6. Tire pressure monitoring system as claimed in claim 4 or 5,
characterized in that the central receiving unit does not include a device for the independent allocation of the pressure measuring values to the respective mounting position of the wheel comprising a pressure sensor.

7. Tire pressure monitoring system as claimed in at least any one of claims 1 to 5,
characterized in that the wheel-individual tire pressure measuring modules are configured as measuring and transmitting devices structurally integrated in the wheel valves.

8. Tire pressure monitoring system as claimed in at least any one of claims 1 to 6,
characterized in that the central evaluating device is an electronic brake control unit for e.g. ABS, TCS, ESP, EMB, EHB, etc.

9. Tire pressure monitoring system as claimed in at least any one of claims 1 to 7,
characterized in that the receiving device for the wheel modules of a wheel is structurally grouped with the wheel speed sensors correspondingly provided on this wheel.

10. Method for tire pressure monitoring, in particular in a system as claimed in any one of claims 1 to 8,
characterized in that the inflation pressure currently prevailing in the individual wheels is detected by means of wheel-individual pressure-measuring and transmitting devices and relayed to a central receiving device installed in the motor vehicle, and that the pressure measuring values are allocated to the respective mounting position of a wheel comprising a pressure sensor by means of a second pressure monitoring system that determines the tire pressure exclusively by comparing and evaluating the rotational behavior of the individual vehicle wheels.

11. Method as claimed in claim 10,
characterized in that each pressure measuring device can send an individual identification key making the pressure measuring devices distinguishable.
